(19) United States
(12) Patent Application Publication
(10) Pub. No.: US 2007/0011164 A1
(43) Pub. Date: Jan. 11, 2007

(54) Method of constructing database management system

(76) Inventors: Keisuke Matsubara, Fujisawa (JP); Masataka Kan, Yokohama (JP); Yukio Nakano, Oyama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/477,465

(22) Filed: Jun. 30, 2006

(30) Foreign Application Priority Data
Jun. 30, 2005 (JP) 2005-191702

(51) Int. Cl. G06F 17/30

(52) U.S. Cl. 707/8

(57) ABSTRACT

In a database management system constructing method of constructing a database management system including a plurality of information processing devices, there are provided a step of creating a definition file and storing the definition file into storage devices, and a step of delivering the stored definition file to each of the information processing devices via a communications device, the information processing devices configuring the database management system. Here, the definition file defines the total number of database processing servers in which database processing servers of an information processing device where a failure has occurred are equally distributable into a plurality of information processing devices other than the information processing device at the time of the failure occurrence corresponding to each number-of-times of multi-failure tolerant number-of-times which indicates tolerant number-of-times of multi failures, and the information processing devices for executing the database processing servers.

### INCORPORATION BY REFERENCE

The present application claims priority from Japanese application JP2005-191702 filed on Jun. 30, 2005, the content of which is hereby incorporated by reference into this application.

### BACKGROUND OF THE INVENTION

1. Field of the Invention

The present invention relates to a database management system constructing technology for constructing a database management system of parallel-server configuration. More particularly, it relates to a technology which is effective when applied to a database management system constructing technology for constructing a database management system which performs the system fail-over when a failure has occurred.

2. Description of the Related Art

The technology of the system fail-over has been employed as a method for enhancing availability of the database management system. The system fail-over is a technology for recovering the system, and shortening a service-down time due to the occurrence of a failure. Here, this recovery and shortening is accomplished by switching the processing in a machine where this failure has occurred over to the processing in another machine.

In the database management system-to which the system fail-over control is applied, a machine which is supposed to become a switching destination at the time of a failure occurrence has been defined on each machine basis which is executing a service at present. Moreover, if the system has detected a failure in an execution-system (i.e., operation-system) machine, the system will perform the system fail-over to a standby-system machine. As this kind of technology, there has been known a one disclosed in, e.g., JP-A-2001-282763.

In the system fail-over, at first, resources in the execution system, e.g., discs storing the database therein and the network address, are switched to resources in the standby system. When the resource switching has been completed, database server in the standby system makes reference to log in the database inherited from the execution system, thereby executing a recovery processing for the database. At a point-in-time when the database recovery processing has been completed, the standby system starts reception of the service, thereby becoming an execution system. This step completes the system fail-over. This technology has been explained in Jim Gray and Andreas Reuter: “Transaction processing: concept and techniques”, Morgan Kaufmann Publishers, 1993.

When applying the system fail-over to a database management system where a plurality of database servers operate on one and the same machine, the following configuration can be employed: Namely, systems of a plurality of database servers on a single machine where a failure has occurred will be switched to a plurality of different machines. The processing in the single machine where the failure has occurred is inherited by the plurality of different machines in a shared manner, thereby distributing load within the failure. This configuration makes it possible to suppress a load increase in the switching-destination machines. Here, concerning to which switching-destination machine each of the plurality of switching targets will switch its system, user has studied the plan in advance, and has described it into a definition file at the time of system initial construction.

Generally speaking, as specs of machines which configure the database management system, machines of basically the same performance are used. Accordingly, distributing the load equally or substantially equally results in the highest processing efficiency as the system as a whole.

In constructing the system, the user describes system information, such as placement of the database servers in each machine on the system, into the definition file. Then, the system is started up based on this definition file. When applying the system fail-over configuration thereto, as described earlier, the information on the system fail-over is also defined simultaneously. In many cases, no consideration has been given to the balance among loads occurring after the system fail-over. The system guarantees none of the balance of the loads among all the machines occurring after the system fail-over. Consequently, at the time of system initial construction, the user must design the system so that the loads will also be balanced among all the machines after the system fail-over.

At the time of system initial construction, the user must design the system correctly by taking into consideration the balance of the loads among all the machines occurring after the system fail-over. If the user fails to do this task, the load balance in the system will become unequal at the time of initial start-up, or at the time when a failure has occurred and the system fail-over is performed. As a result, the loads become biased, and are concentrated onto a particular machine after the system fail-over. This situation, in some cases, lowers throughput of the entire system.

### SUMMARY OF THE INVENTION

It is an object of the present invention to provide a technology for making it possible to solve the above-described problem, and to guarantee that, at the initial start-up time and after the system fail-over, the loads among all the information processing devices will become equal or substantially equal.

It is another object of the present invention to provide a technology for making it possible to reduce a load for re-inputting the system configuration of an already-existing database management system.

In the present invention, in a database management system constructing device for constructing a database management system, the database management system storing a database such that the database is divided into a plurality of storage areas, and performing a data processing by causing a database processing server to be related to each storage area, the database management system is constructed by calculating the number of the database processing servers which becomes equally distributable into information processing devices that are under operation at the time of a failure occurrence.

In the database management system constructing device of the present invention, after having read input information which includes the number of information processing devices configuring the database management system, and multi-failure tolerant number-of-times indicating tolerant number-of-times of multi failures, when, of the read number of information processing devices, a failure has occurred in an information processing device corresponding to each number-of-times of the multi-failure tolerant number-of-times, the total number of database processing servers, in which database processing servers of the information processing device where the failure has occurred are equally distributable into the other information processing devices, is calculated, and correspondences between the database processing servers and database-used storage devices are determined, and a system-configuration definition file including these pieces of information is stored into the storage devices.

Next, the calculated total number of database processing servers are allocated to each information processing device which is made operable at initial start-up time or at system fail-over time, thereby determining an information processing device which is to execute each database processing server at the initial start-up time or at the system fail-over time. After that, a system fail-over definition file where these pieces of information are set is stored into the storage devices.

After that, the stored system-configuration definition file is delivered via a communications device to each of the information processing devices configuring the database management system. In each information processing device, the database processing servers are executed based on the delivered definition file, thereby performing the database processing. At the time of a failure occurrence, the system fail-over is performed. Based on this system fail-over, the database processing servers which had been executed in the information processing device where the failure has occurred will be executed by the information processing device specified in the system fail-over definition file.

According to the present invention, it becomes possible to guarantee that, at the initial start-up time and after the system fail-over, the loads among all the information processing devices will become equal or substantially equal.

### BRIEF DESCRIPTION OF THE DRAWINGS

FIG. 1 is a diagram for illustrating overview of a database management system constructing device in a first embodiment;

FIG. 2 is a diagram for illustrating schematic configuration of a setting machine 100 in the first embodiment;

FIG. 3 is a diagram for illustrating overview of a database management system in the first embodiment;

FIG. 4 is a diagram for illustrating overview of input information 107 in the first embodiment;

FIG. 5 is a diagram for illustrating overview of a system-configuration definition file 108 in the first embodiment;

FIG. 6 is a flowchart for illustrating processing steps of a system-configuration determination processing unit 300 in the first embodiment;

FIG. 7 is a flowchart for illustrating processing steps of DB-processing-server number determination processing in the first embodiment;

FIG. 8 is a flowchart for illustrating processing steps of system fail-over sequence determination processing in the first embodiment;

FIG. 9 is a diagram for illustrating an example of system construction in the first embodiment;

FIG. 10 is a diagram for illustrating overview of a system fail-over definition table in the first embodiment;

FIG. 11A to FIG. 11C are diagrams for illustrating a determination example of the system fail-over sequence in the first embodiment;

FIG. 12 is a diagram for illustrating an example of the system fail-over in the first embodiment;

FIG. 13 is a diagram for illustrating a system fail-over function-unapplied configuration example in a second embodiment;

FIG. 14 is a diagram for illustrating overview of a processing for applying the system fail-over function to a system fail-over function-unapplied system in the second embodiment;

FIG. 15 is a flowchart for illustrating processing steps of a system-configuration determination processing unit 300a in the second embodiment;

FIG. 16 is a diagram for illustrating a configuration example at the time of specifying the standby-machine number in a third embodiment;

FIG. 17 is a flowchart for illustrating processing steps of the system-configuration determination processing unit 300a in the third embodiment;

FIG. 18 is a flowchart for illustrating processing steps of the system fail-over sequence determination (1701) in the third embodiment;

FIG. 19 is a flowchart for illustrating processing steps of a system fail-over definition determination processing unit 1900 in the third embodiment;

FIG. 20 is a flowchart for illustrating processing steps of the system fail-over sequence determination (1902) in the third embodiment; and

FIG. 21 is a diagram for illustrating an example of the system fail-over in the third embodiment.

### DESCRIPTION OF THE INVENTION

### Embodiment 1

Hereinafter, the explanation will be given below concerning a database management system constructing device in a first embodiment for constructing a database management system including a plurality of information processing devices.

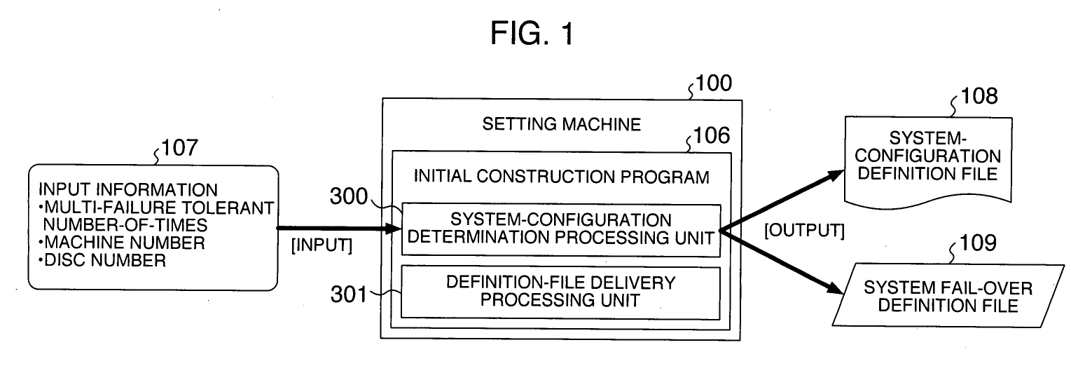

FIG. 1 is a diagram for illustrating overview of a database management system constructing device in the present embodiment. First, referring to FIG. 1, the explanation will be given below concerning the overview of the present embodiment.

The database management system indicated in the present embodiment is constructed by a setting machine 100 which is the database management system constructing device. In the setting machine 100, an initial construction program 106 is operating. The initial construction program 106 includes a system-configuration determination processing unit 300 and a definition-file delivery processing unit 301. Incidentally, it is assumed that machines in the present embodiment are the information processing devices.

The system-configuration determination processing unit 300 receives input information 107. This input information 107 includes information such as multi-failure tolerant number-of-times and the number of discs on the system. Based on this input information 107, the system-configuration determination processing unit 300 determines a system-configuration definition and a system fail-over definition in which, even if failures have occurred up to the specified tolerant number-of-times, the loads will become equal among all the remaining machines. Then, the unit 300 outputs this determined contents as a system-configuration definition file 108 and a system fail-over definition file 109.

The system-configuration definition file 108 describes respective types of settings needed for constructing the system. The system fail-over definition file 109 describes information on configuration of the system fail-over and system fail-over destination for each DB processing server. Moreover, the definition-file delivery processing unit 301 delivers the system-configuration definition file 108 and the system fail-over definition file 109 to each machine.

A program for allowing the setting machine 100 in the present embodiment to function as the system-configuration determination processing unit 300 and the definition-file delivery processing unit 301 is recorded into a record medium such as CD-ROM, and is stored into a magnetic disc or the like. After that, the program is loaded onto a memory, then being executed. Incidentally, the record medium for recording the above-described program may also be another record medium other than the CD-ROM. Also, the program may be used by installing the program into the information processing devices from the record medium. Also, the program may be used by accessing the record medium via a network.

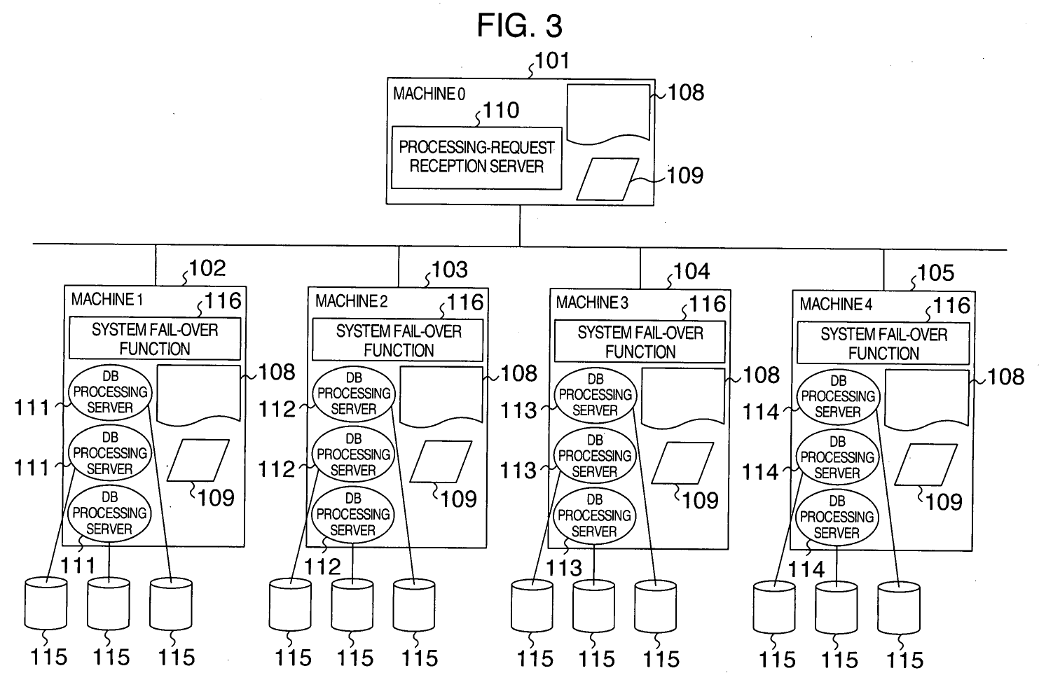

FIG. 3 is a diagram for illustrating overview of the database management system in the present embodiment. FIG. 3 illustrates a configuration example of the database management system to be constructed. The setting machine 100 delivers the system-configuration definition file 108 and the system fail-over definition file 109 created to a machine 0 (101), a machine 1 (102), a machine 2 (103), a machine 3 (104), and a machine 4 (105).

In the machine 0 (101), the machine 1 (102), the machine 2 (103), the machine 3 (104), and the machine 4 (105), based on the definition information in the system-configuration definition file 108, database processing servers are started up, thereby configuring the system. What are called “database processing servers” here refer to database-processing execution environments which include process groups, memory areas, and the like. Namely, the “database processing servers” means database processing functions provided by executing programs for the database processing servers. External storage devices 115, each of which forms a pair with each of the DB processing servers 111 to 114, store the DB data therein. Also, a system fail-over function 116 is operating in each machine in which the DB processing servers are located. The system fail-over function 116 monitors operation situation of the DB processing servers in each machine. Then, at the time of a failure occurrence, the function 116 switches the system in accordance with the contents in the system fail-over definition file 109.

Architecture of the database management system in the present embodiment is Shared Nothing architecture. The database (e.g., table or index) managed by the present system is divided into a plurality of division tables and division indexes by using various techniques, then being stored in the divided manner into a plurality of DB storage areas within the external storage devices 115. A certain DB storage area is caused to correspond to a determined DB processing server. A DB processing server will access only the data (e.g., table data or index data) stored within a DB storage area which is caused to correspond to the DB processing server.

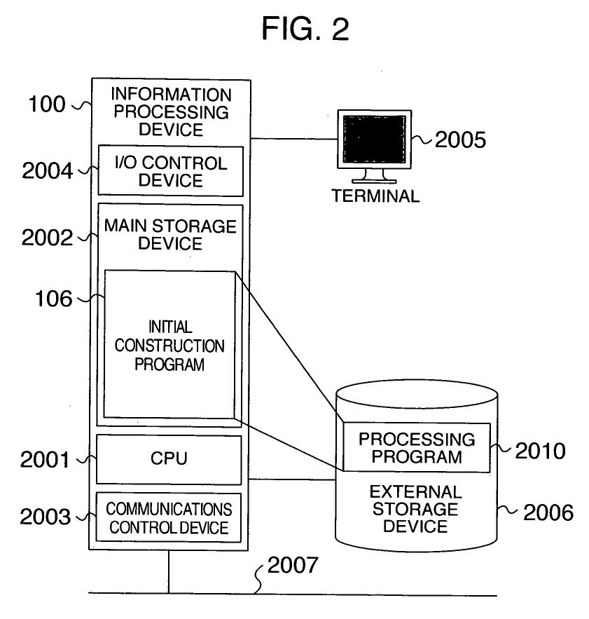

FIG. 2 is a diagram for illustrating schematic configuration of the setting machine 100 in the present embodiment. Next, referring to FIG. 2, the explanation will be given below concerning the configuration of the setting machine 100 in the present embodiment.

The setting machine 100 includes a CPU 2001, a main storage device 2002, a communications control device 2003, an I/O control device 2004, a terminal 2005, and an external storage device 2006 such as a magnetic disc. The communications control device 2003 is a device for controlling communications between the setting machine 100 and the other machines via a network 2007. The I/O control device 2004 is a device for controlling read/write of data from/into the external storage device 2006.

A processing program 2010 for implementing the initial construction program 106 is stored on the external storage device 2006. The CPU 2001 loads the initial construction program 106 onto the main storage device 2002, then executing the program 106. Also, the CPU 2001 receives input of the input information 107 from the user.

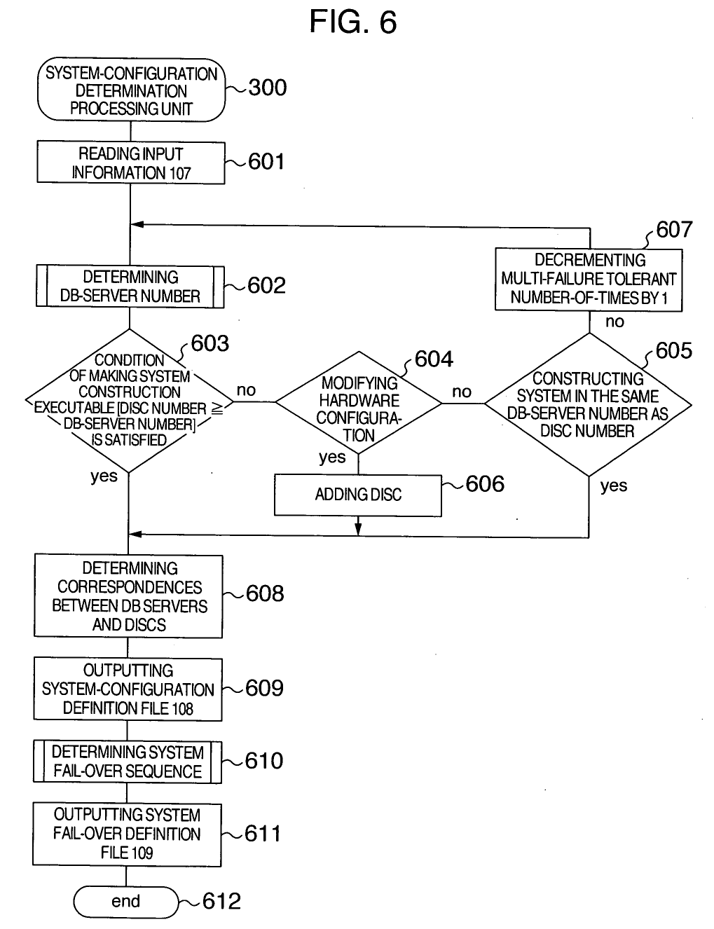

FIG. 6 is a flowchart for illustrating processing steps of the system-configuration determination processing unit 300 in the present embodiment. First, at a step 601, the system-configuration determination processing unit 300 in the setting machine 100 reads the input information 107 inputted from the user using the terminal 2005 and an input device. As a result, the unit 300 acquires the total number of the machines configuring the database management system, the total number and names of the co-use discs for storing the DB data, and the multi-failure tolerant number-of-times.

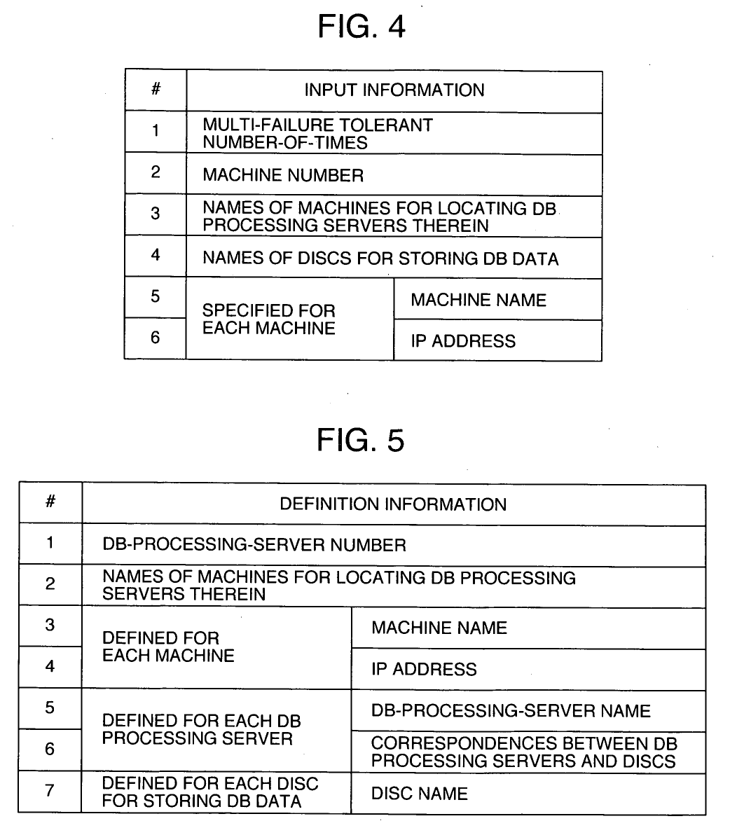

FIG. 4 is a diagram for illustrating overview of the input information 107 in the present embodiment. As illustrated in FIG. 4, the input information 107 includes the multi-failure tolerant number-of-times indicating tolerant number-of-times of multi failures, the number of the machines configuring the database management system, machine name and IP address for each machine, names of machines for locating the DB processing servers therein, the number of the discs for storing the DB data, and name of each disc for storing the DB data.

Next, at a step 602, the system-configuration determination processing unit 300 determines the DB-processing-server number in which the loads will become equal among all the operating machines even after the system fail-over. Moreover, at a step 603, the unit 300 judges whether or not the system construction is executable. In the database management system in the present embodiment, it is assumed that a single DB processing server exclusively occupies a single external storage device 115. It is also assumed that the judgment as to whether or not the system construction is executable is performed by making a comparison between the DB-processing-server number calculated at the step 602 and the disc number in the system acquired from the input information 107.

If the disc number is smaller than the DB-processing-server number, the unit 300 judges that the system construction is impossible. Accordingly, the unit 300 outputs, to an output device, a notification that DB processing servers of a failed machine cannot be equally distributed into the operating machines. After that, at a step 604, the unit 300 notifies the user of the number of the discs whose addition is necessary by outputting the number of the discs to the output device. Then, the unit 300 receives a response to this notification via the input device, thereby confirming the possibility or impossibility of the addition of the discs. If the addition of the discs is permissible, at a step 606, the unit 300 acquires information on the discs in the necessary number.

Meanwhile, if, at the step 604, the addition of the discs is impossible, at a step 605, the unit 300 outputs, to the output device, an inquiry as to whether or not the system will be constructed with the DB-processing-server number equivalent to the disc number specified in the input information 107. Then, the unit 300 receives an instruction thereto from the user via the input device.

If, at the step 605, the unit 300 receives the instruction from the user that the system will not be constructed with the DB-processing-server number equivalent to the disc number specified in the input information 107, the unit 300 proceeds to a step 607. Here, the unit 300 decrements, by “1”, the value of the multi-failure tolerant number-of-times specified in the input information 107. The case of having decremented the number-of-times of the multi failures to be tolerated makes it possible to construct the system with the use of the smaller DB-processing-server number, i.e., the smaller disc number. Furthermore, the unit 300 returns to the step 602, then determining the DB-processing-server number once again.

Meanwhile, if, in the processing at the step 605, the unit 300 receives the instruction from the user that the system will be constructed with the DB-processing-server number equivalent to the disc number specified in the input information 107, the unit 300 proceeds to a step 608, assuming that the DB-processing-server number is the same number as the disc number specified in the input information 107.

At the step 608, the unit 300 determines correspondences between the DB processing servers and the discs, then proceeding to a step 609. At the step 609, the unit 300 outputs, to the external storage device 2006 and as the system-configuration definition file 108, system-configuration information including the determined DB-processing-server number and the correspondences between the DB processing servers and the discs. At a step 610, the unit 300 determines a system fail-over sequence by setting machines for executing the DB processing servers at the initial start-up time, and machines which become system fail-over destinations at the system fail-over time. At a step 611, the unit 300 outputs information indicating the system fail-over sequence to the external storage device 2006 and as the system fail-over definition file 109.

FIG. 5 is a diagram for illustrating overview of the system-configuration definition file 108 in the present embodiment. As illustrated in FIG. 5, the system-configuration definition file 108 includes the DB-processing-server number, the machine name and IP address for each machine, the name of each disc for storing the DB data, the names of the machines for locating the DB processing servers therein, the name of each DB processing server, and information indicating the correspondences between the DB processing servers and the discs.

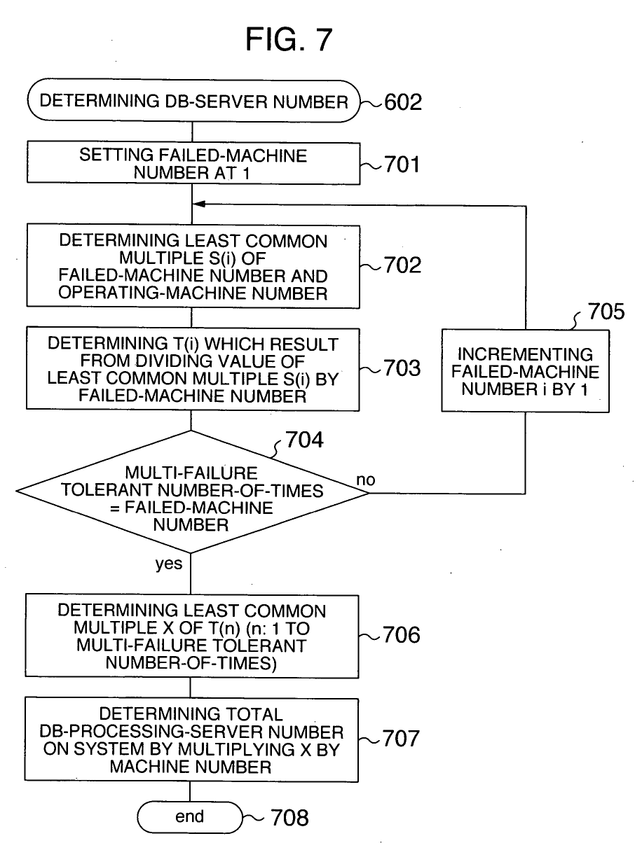

FIG. 7 is a flowchart for illustrating processing steps of the DB-processing-server number determination processing in the present embodiment. FIG. 7 illustrates details of the processing contents at the step 602 in the flowchart in FIG. 6.

First, at a step 701, the failed-machine number i is set at “1”, then proceeding to a step 702. At the step 702, after determining the operating-machine number from the difference between the machine number and the failed-machine number i, value of the least common multiple S(i) of the failed-machine number i and the operating-machine number is determined. Moreover, at a step 703, value T(i) is determined which results from dividing the value of the least common multiple S(i) by the failed-machine number i.

At a step 704, it is judged whether or not the value of the failed-machine number i has reached the multi-failure tolerant number-of-times. If the value has not reached the multi-failure tolerant number-of-times, the processing proceeds to a step 705. At the step 705, the value of the failed-machine number i is incremented by “1”, then proceeding to the step 702. Meanwhile, if, at the step 704, it is judged that the value of the failed-machine number i has reached the multi-failure tolerant number-of-times, the processing proceeds to a step 706.

At the step 706, the least common multiple X of all the values T(n) which have been determined at the step 703 up until now is determined. Here, n denotes values ranging from 1 to the multi-failure tolerant number-of-times. At a step 707, value of the total DB-processing-server number on the system is determined. The value of X determined at the step 706 turns out to become the DB-processing-server number per machine. Accordingly, the value of the total DB-processing-server number is determined by multiplying this value of X by the machine number. Also, here, server names from DB server 00 to DB server X are allocated to the respective DB processing servers.

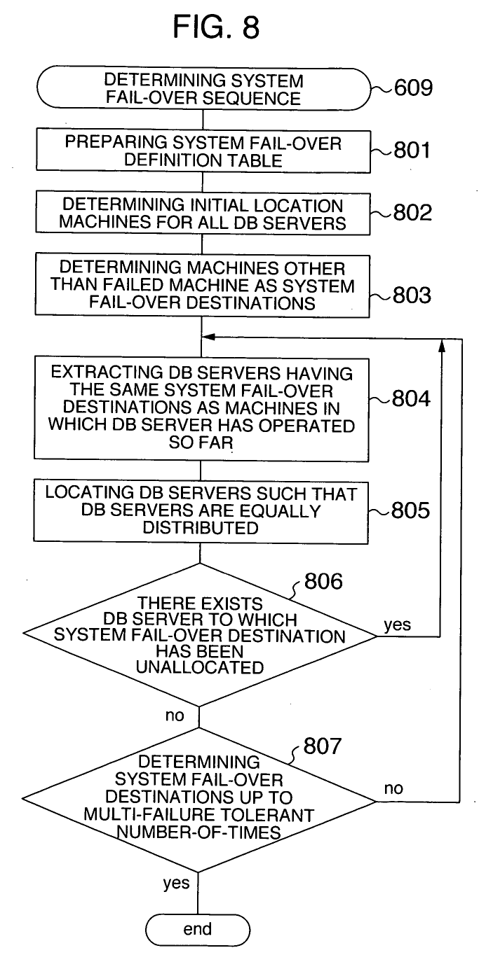

FIG. 8 is a flowchart for illustrating processing steps of the system fail-over sequence determination processing in the present embodiment. FIG. 8 illustrates details of the processing contents at the step 610 in the flowchart in FIG. 6.

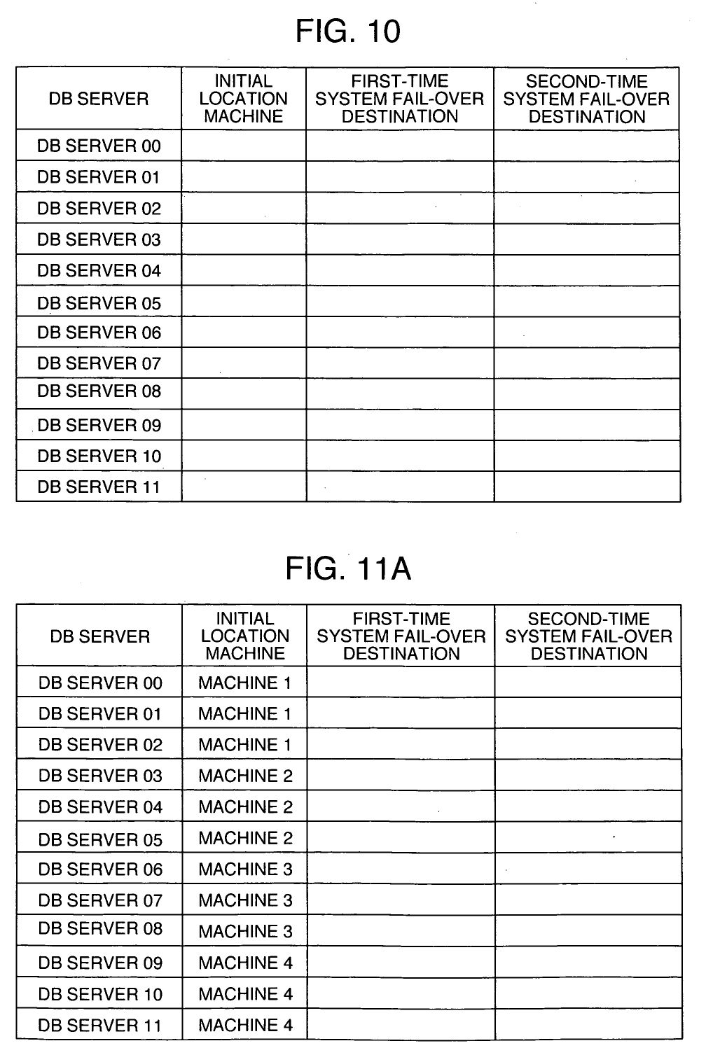

FIG. 10 is a diagram for illustrating overview of a system fail-over definition table in the present embodiment. At a step 801, a system fail-over definition table 1000 as is illustrated in FIG. 10 is prepared. The system fail-over definition table 1000 is a table for specifying an initial location machine for each DB processing server, and names of machines of system fail-over destinations for each DB processing server up to the multi-failure tolerant number-of-times.

At a step 802, an initial location machine in which each DB processing server is located at the initial start-up time is determined. Here, the DB-processing-server number determined at the step 602 is divided by the machine number. Next, the DB processing servers are sequentially allocated to the machines in this division unit, then storing names of the machines into the field of the initial location machine in the system fail-over definition table 1000. Here, if the DB-processing-server number can not be equally divided, it will be divided as equally as possible.

Next, at a step 803, system fail-over destinations at the first time are determined for each DB processing server. Among DB processing servers which have been located in one and the same machine as their initial location machine, the machines other than this initial location machine are equally allocated to the DB processing servers. Next, names of the other machines are stored into the field of the system fail-over destinations at the first time in the system fail-over definition table 1000, then proceeding to a step 804.

Moreover, at a step 804 or thereinafter, machines which become system fail-over destinations at the second time or thereinafter are determined. At the step 804, all of the DB processing servers are extracted which have been located so far in the machines which become the same as the location machines in a DB processing server supposed to determine the system fail-over destination machine. Furthermore, the processing proceeds to a step 805.

At the step 805, the system fail-over destination machines are determined so that the DB processing servers extracted at the step 804 will be located in a manner of being equally distributed into the machines other than the machines in which the DB processing servers have been located so far. Next, names of the machines are stored into the fields of the fail-over destinations at the second time or thereinafter in the system fail-over definition table 1000, then proceeding to a step 806.

At the step 806, it is confirmed whether or not there exists a DB processing server to which the system fail-over destination machine has been unallocated. If there exists the unallocated DB processing server, the processing returns to the step 804, then continuing the allocation. Meanwhile, if there exists none of the unallocated DB processing server, the processing proceeds to a step 807.

At the step 807, it is confirmed whether or not all the fields of the system fail-over definition table 1000 have been filled. If all the fields have been not filled, the processing returns to the step 804, then continuing the determination of the system fail-over destination. Meanwhile, if all the items of the system fail-over definition table 1000 have been filled, the processing proceeds to a step 808 then to terminate the processing flow for the system fail-over sequence determination.

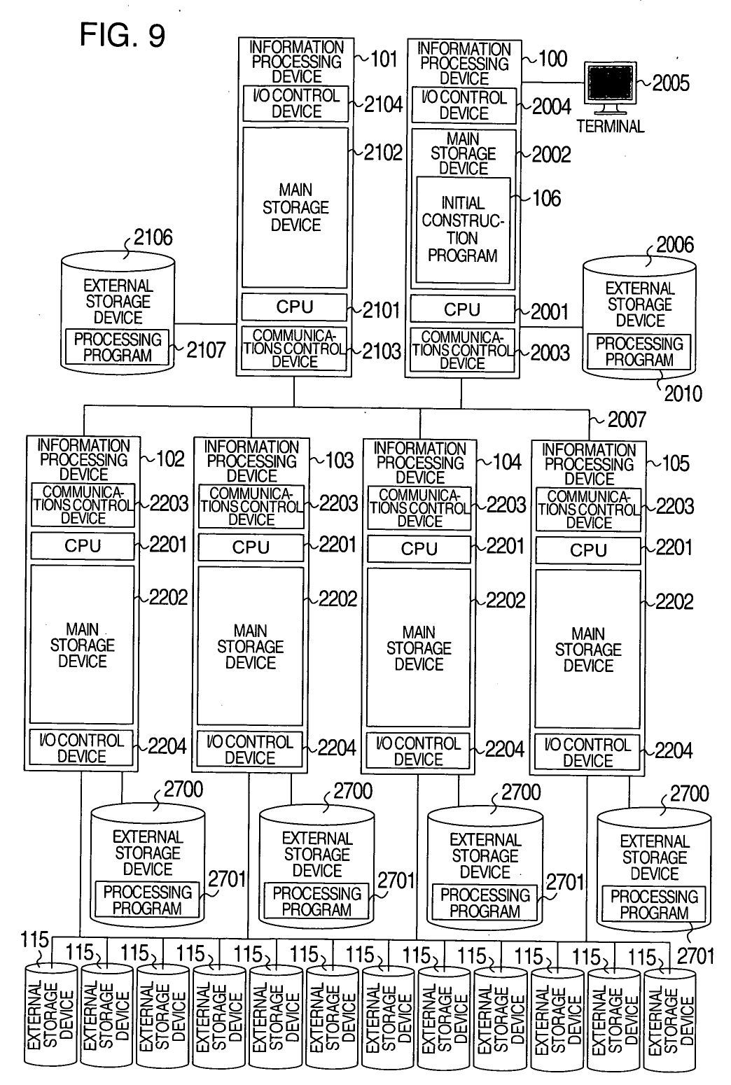

Next, the explanation will be given below concerning a processing example in the case of constructing a database management system of the configuration in FIG. 9.

FIG. 9 is a diagram for illustrating an example of the system construction in the present embodiment. As illustrated in FIG. 9, a machine 0 (101) includes a CPU 2101, a main storage device 2102, a communications control device 2103, an I/O control device 2104, and an external storage device 2106 such as a magnetic disc. A processing program 2107 for implementing the processing-request reception server 110 of database management system is stored on the external storage device 2106. The processing-request reception server 110 is operated on the main storage device-2102 using the CPU 2101.

Each of a machine 1 (102), a machine 2 (103), a machine 3 (104), and a machine 4 (105) includes a CPU 2201, a main storage device 2202, a communications control device 2203, an I/O control device 2204, an external storage device 2700 such as a magnetic disc, and external storage devices 115. The external storage devices 115, which are co-use disc devices, can be accessed from each of the machine 1 (102), the machine 2 (103), the machine 3 (104), and the machine 4 (105). The external storage devices 115 permanently or temporarily store thereon the data which becomes access target in the present database management system. The external storage devices 115 are the co-use disc devices, and the system fail-over function controls the accesses to the co-use disc devices.

A processing program 2701 for implementing the DB processing servers is stored on the external storage device 2700. A DB processing server in the operating state is operated on the main storage device 2202 using the CPU 2201. The DB processing server performs read/write of the data from/into the external storage devices 115 and 2700 by the I/O control device 2204, then performing transmission/reception of the data with the machines connected thereto by the communications control device 2203 via a network 2500.

First, the user inputs the input information 107. Hereinafter, the system definition will be determined in accordance with the flowchart in FIG. 6.

In accordance with the step 601, the system-configuration determination processing unit 300 in the setting machine 100 reads the contents of the input information 107. Here, the machines for locating the DB processing servers therein are four in number, and the external storage devices 115 for storing the DB data are twelve in number. Also, here, the multi-failure tolerant number-of-times are set at two number-of-times. Namely, the present database management system is configured into a system in which, even if a failure has occurred two number-of-times therein, its operation can be continued by distributing the load.

Next, in accordance with the step 602, the unit 300 determines the DB-processing-server number. The DB-processing-server number will be determined in accordance with the flowchart in FIG. 7.

First, in accordance with the step 701, the failed-machine number i is set at “1”. Next, in accordance with the step 702, the least common multiple S1 of the failed-machine number i and the operating-machine number is determined. In the present example, the machine number for locating the DB processing servers therein is “4”. Accordingly, when the failed-machine number is “1”, the operating-machine number becomes equal to “3”. Consequently, S1 becomes a least common multiple of “1” and “3”, thereby becoming equal to “3”. Next, the processing proceeds to the step 703, where the value of T1 is determined as being “3” by dividing the value “3” of S1 by the failed-machine number “1”.

In the judgment at the step 704, the value of the failed-machine number i is “1”. Accordingly, the failed-machine number i has not reached the value “2”of the multi-failure tolerant number-of-times in the present example, thus proceeding to the step 705. At the step 705, the value of the failed-machine number i is incremented by “1”, thereby making the failed-machine number i equal to “2”. Moreover, the processing proceeds the step 702 once again, where the least common multiple S2 is determined. The least common multiple S2 is a least common multiple of the value “2” of the failed-machine number i and the operating-machine number “2”, which results from subtracting the value “2” of the failed-machine number i from the machine number “4”. Consequently, the least common multiple S2 becomes equal to “2”. Furthermore, the processing proceeds to the step 703, where the value of T2 is determined. The value of T2 becomes equal to “1” by dividing the value “2” of S2 by the value “2” of the failed-machine number i. In addition, the processing proceeds to the step 704.

At the step 704, the value of the multi-failure tolerant number-of-times is “2”, and the value of the failed-machine number i is “2”. Accordingly, the judgment result turns out to be affirmative, thus proceeding to the step 706. At the step 706, the value X of the least common multiple is determined from all the values of T which have been determined at the step 703 up until now. In the present example, since T1 has been found to be “3” and T2 has been found to be “1”, the value X of the least common multiple becomes equal to “3”.

At the step 707, the value of the total DB-processing-server number on the system is determined by multiplying the value X by the machine number. Since the value X is “3” and the machine number is “4”, the total DB-processing-server number on the system becomes equal to “12”.

Next, the judgment at the step 603 is carried out. In the present construction example, since the DB-processing-server number is “12” and the disc number is “12”, the system is constructible. In the present embodiment, it is required to cause the discs to correspond to the DB processing servers individually. Accordingly, if the disc number lacks, additional installment of the discs or the like is required. Moreover, in accordance with the step 608, the correspondences between the respective DB processing servers and the respective discs are determined. Furthermore, at the step 609, the system-configuration definition file 108 is outputted.

Next, in accordance with the step 610, the unit 300 determines the system fail-over sequence. The system fail-over sequence will be determined in accordance with the flowchart in FIG. 8.

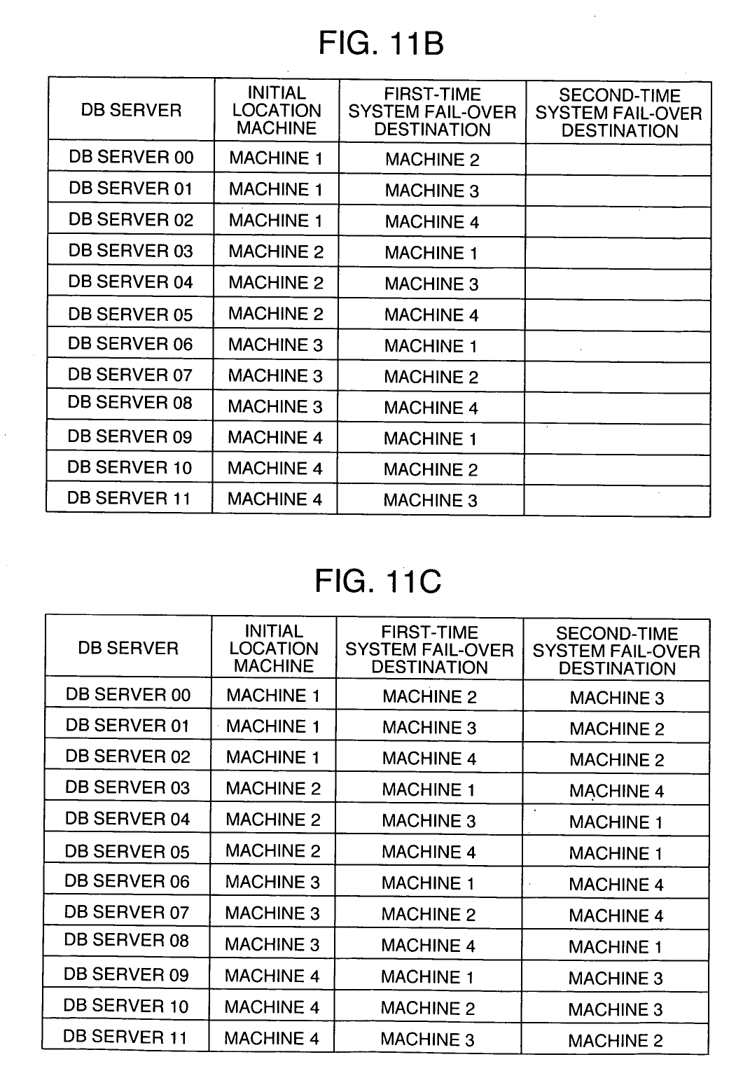

FIG. 11A to FIG. 11C are diagrams for illustrating a determination example of the system fail-over sequence in the present embodiment. The example in FIG. 11A to FIG. 11C indicates the manner of determining the initial location machines in which the DB processing servers are located at the initial start-up time, the machines of the system fail-over destinations at the first time, and the machines of the system fail-over destinations at the second time.

First, at the step 801, the system fail-over definition table is prepared. After that, at the step 802, the initial location of all the DB processing servers is determined. Namely, the twelve DB processing servers determined at the step 602 are going to be located into the four machines. The DB processing servers are sequentially distributed into the machines with the three servers distributed for each machine (FIG. 11A), then proceeding to the step 803.

At the step 803, the system fail-over destinations at the first time are determined. This task is satisfying enough only to determine the system fail-over destinations in the case where a failure has occurred in any one of the four machines. Accordingly, the DB processing servers in each machine are sequentially distributed into the machines other than their initial location machine, thereby determining the system fail-over sequence (FIG. 11B). Then, the processing proceeds to the step 804.

Moreover, in accordance with the step 804, the system fail-over destinations at the second time or thereinafter for each DB processing server are determined. For example, when determining the system fail-over destination for the DB server 00, another DB processing server is extracted which has been located in the machines of the combination of the machine 1 and the machine 2 in which the DB server 00 has been located so far. Here, the DB server 03 corresponds to this DB processing server to be extracted.

Next, the processing proceeds to the step 805. The DB server 00 and the DB server 03 are located into the machines other than the machine 1 and the machine 2 in a manner of being distributed thereto. Here, the DB server 00 is located into the machine 3, and the DB server 03 is located into the machine 4. Hereinafter, in accordance with the judgment at the step 806, the system fail-over destination at the second time for each server is determined (FIG. 11C).

In the present example, the multi-failure tolerant number-of-times are set at two number-of-times. Consequently, the definition on the system fail-over sequence is completed with the determination of the system fail-over destinations at the second time. If the multi-failure tolerant number-of-times is specified at larger number-of-times, in accordance with the judgment at the step 807, the system fail-over destination machine is similarly determined for each DB processing server.

Furthermore, in accordance with the step 611, the unit 300 outputs the determined contents as the system fail-over definition file 109. In addition, the definition-file delivery processing unit 301 delivers the definition file to the machine 0 (101), the machine 1 (102), the machine 2 (103), the machine 3 (104), and the machine 4 (105), thereby constructing the system.

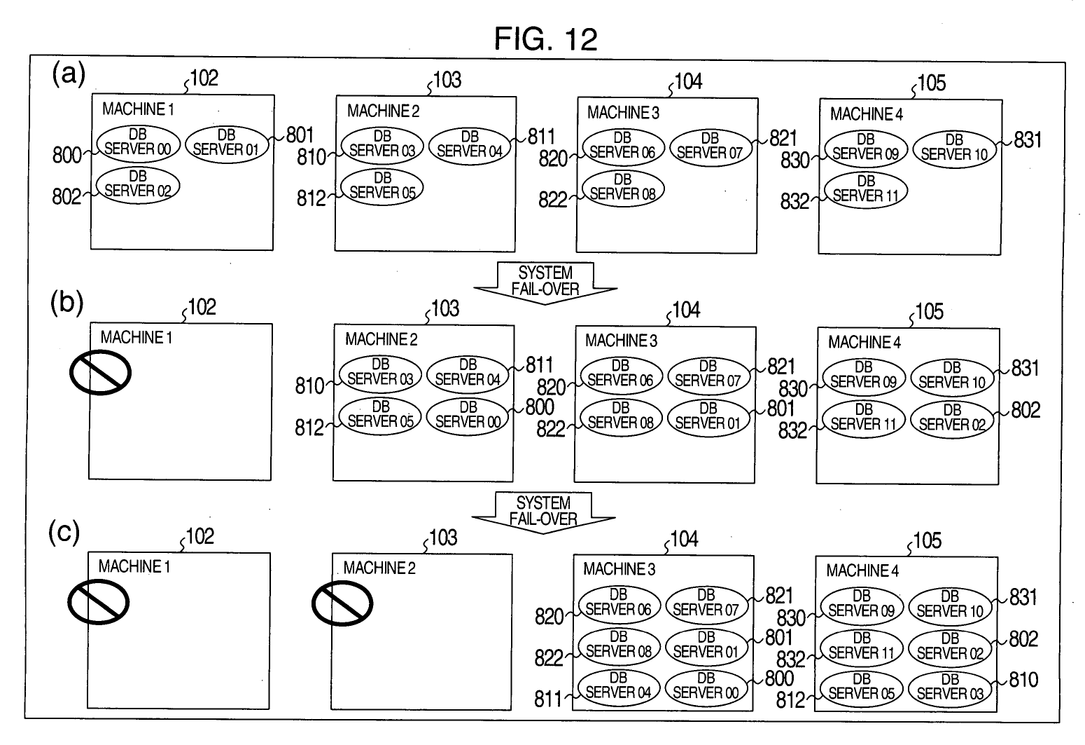

FIG. 12 is a diagram for illustrating an example of the system fail-over in the present embodiment. FIG. 12 illustrates the example where the loads have become equal among all the machines before and after the system fail-over after the completion of the initial construction.

A diagram (a) in FIG. 12 illustrates the respective machines in which the DB processing servers are located at the point-in-time when the initial construction has been completed, and the respective DB processing servers. This location is based on the information on the initial location machines in the system fail-over definition table in FIG. 11A.

A diagram (b) in FIG. 12 illustrates the machine configuration after the system fail-over has been performed because a failure had occurred in the machine 1 (102). Based on the information on the system fail-over destinations at the first time in the system fail-over definition table in FIG. 11B, the DB processing servers which had been operating in the machine 1 (102) are operating in the machine 2 (103), the machine 3 (104), and the machine 4 (105), respectively.

A diagram (c) in FIG. 12 illustrates the machine configuration after the system fail-over has been performed because a failure had occurred in the machine 2 (103)) from the state in the diagram (b) in FIG. 12. Based on the information on the system fail-over destinations at the second time in the system fail-over definition table in FIG. 11C, the DB processing servers which had been operating in the machine 2 (103)) are operating in the machine 3 (104) and the machine 4 (105), respectively.

In this way, FIG. 12 indicates that, even if a plurality of system fail-overs have occurred, the loads are always equal among all the machines under operation.

As having been explained so far, according to the database management system constructing device in the present embodiment, the database management system is constructed by calculating the DB-processing-server number which becomes equally distributable into the information processing devices under operation at the time of a failure occurrence. As a result, it becomes possible to guarantee that, at the initial start-up time and after the system fail-over, the loads among all the information processing devices will become equal or substantially equal.

### Embodiment 2

Hereinafter, the explanation will be given below concerning a database management system constructing device in a second embodiment for constructing a database management system by inputting an already-existing system-configuration definition file.

In the present embodiment, when performing a configuration modification of applying the system fail-over function to a database management system to which the system fail-over function has been not applied, the explanation will be given below concerning a processing of taking advantage of information in the system-configuration definition file 108 of the database management system as the input information 107.

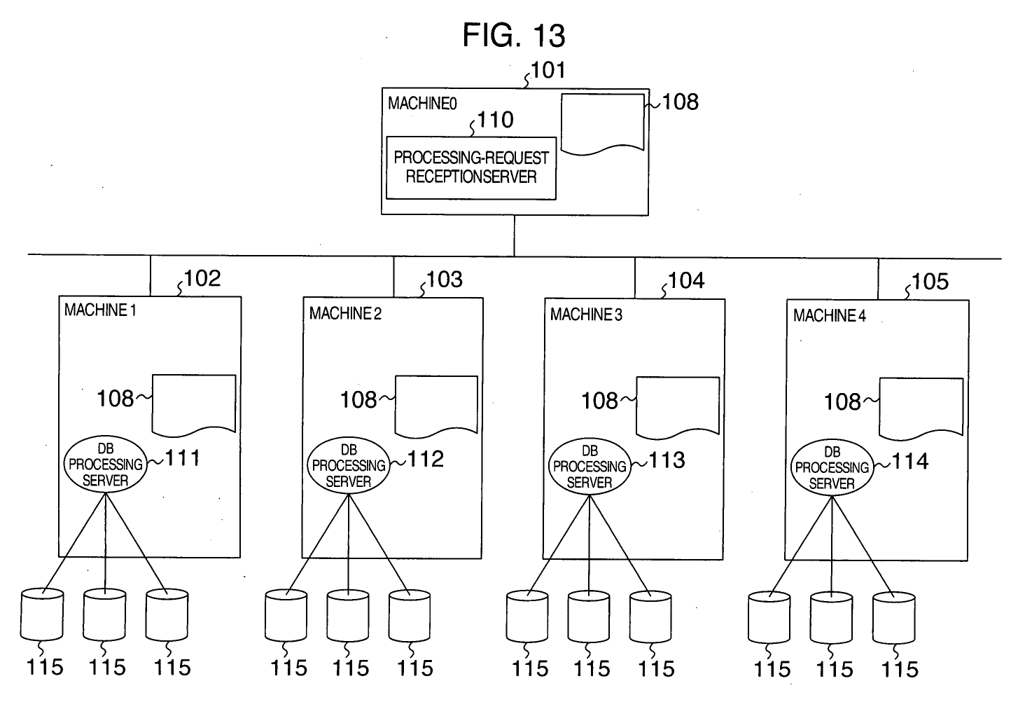

FIG. 13 is a diagram for illustrating a system fail-over function-unapplied configuration example in the present embodiment. Although the database management system in FIG. 13 has basically the same configuration as the one illustrated in FIG. 9, this system has been already operating with the system fail-over function-unapplied configuration. Accordingly, the DB processing servers are operating in the main storage devices 2202.

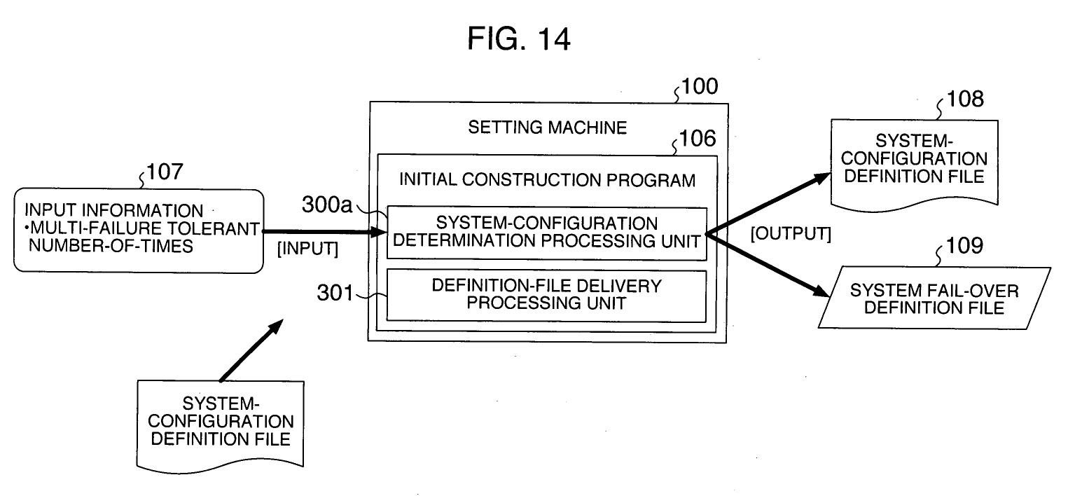

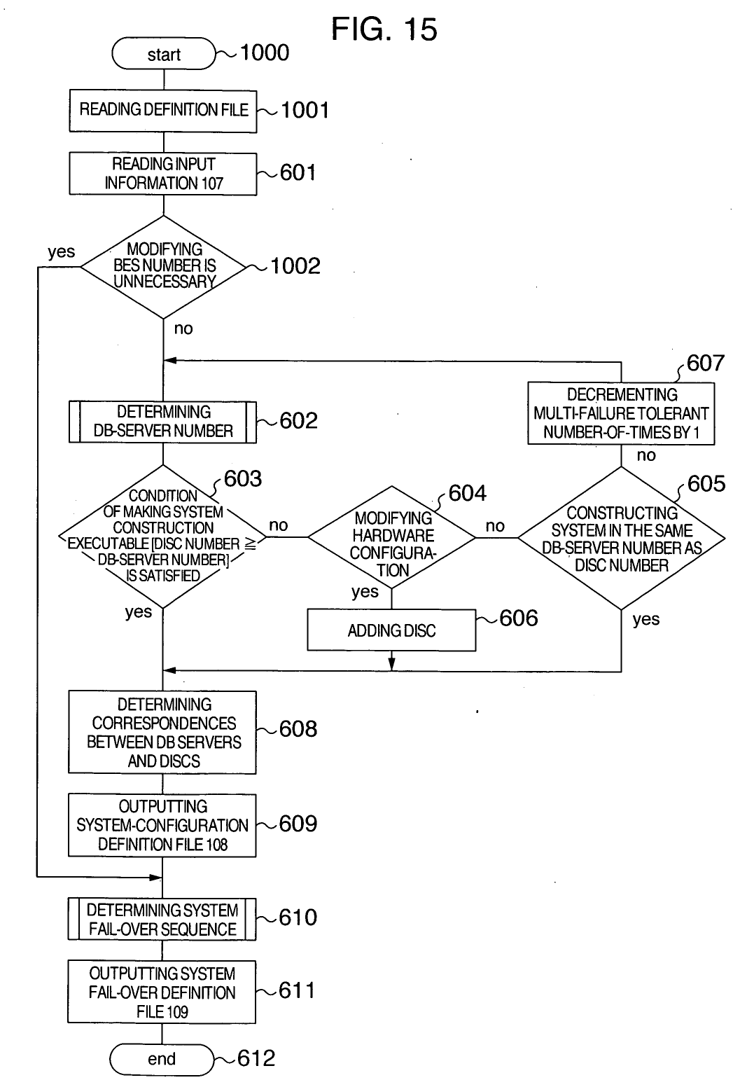

FIG. 14 is a diagram for illustrating overview of a processing for applying the system fail-over function to the system fail-over function-unapplied database management system in the present embodiment. As illustrated in FIG. 14, the initial construction program 106 in the present embodiment includes a system-configuration determination processing unit 300a and the definition-file delivery processing unit 301. The system-configuration determination processing unit 300a outputs the system fail-over definition file 109. A flowchart in FIG. 15 illustrates the processing contents of this system-configuration determination processing unit 300a.

FIG. 15 is the flowchart for illustrating the processing steps of the system-configuration determination processing unit 300a in the present embodiment. First, at a step 1001, the system-configuration determination processing unit 300a reads the already-existing system-configuration definition file of the database management system which has been operating. From the definition file read, the system-configuration determination processing unit 300a acquires the machine configuration and disc configuration of the system. Next, at the step 601, the unit 300a acquires the input information 107. The contents of the input information 107 are only the items not included in the definition information read at the step 1001.

Moreover, at a step 1002, the unit 300a judges whether to employ the configuration of the DB processing servers of the already-existing system, or to employ the configuration where the loads are made equal among all the machines, i.e., whether or not modifying the BES (Back-End Server) number is unnecessary. This judgment is made in accordance with instruction contents inputted from the user via the terminal 2005. Furthermore, at the step 1002, if the unit 300a has judged that the configuration of the DB processing servers be reset, the processing proceeds to the step 602. Meanwhile, if the unit 300a has judged that the already-existing configuration be used, the processing proceeds to the step 610. Hereinafter, processing contents at the step 602, step 603, step 604, step 605, step 606, step 607, step 608, step 609, step 610, and step 611 are basically the same as those in the first embodiment.

Next, the definition-file delivery processing unit 301 delivers the system fail-over definition file 109 to each of the machines configuring the database management system. Each machine performs the system fail-over based on this system fail-over definition file 109, thereby modifying the system into the system of the system fail-over function-applied configuration. Also, if, at the step 1002, the unit 300a has judged that the loads be made equal among all the machines, and if the system-configuration definition file 108 has been created, the definition-file delivery processing unit 301 also delivers the system-configuration definition file 108 to each machine within the system.

Next, the explanation will be given below concerning a concrete example in the case where, when the system is operating with the system fail-over function-unapplied configuration like FIG. 13, the system is modified into the system fail-over function-applied configuration.

First, at the step 1001, the system-configuration determination processing unit 300a reads the system-configuration definition file of the already-existing system. From this information, the unit 300a acquires the machine configuration and disc configuration of the system. In the present example, it is assumed that the machine number for locating the DB processing servers therein is “4”, and that the disc number is “12”.

Next, at the step 1002, the unit 300a determines whether or not the configuration of the DB processing servers should be reset. This time, assuming that the configuration of the DB processing servers should be reset, and that hereinafter, similarly in the first embodiment, the system fail-over definition has been created with the multi-failure tolerant number-of-times set at two number-of-times, the system-configuration determination processing unit 300a creates and outputs the system-configuration definition file 108 and the system fail-over definition file 109. This brings about the result that the DB processing servers which are “12” in number will be located similarly in the construction example in the first embodiment.

Next, the definition-file delivery processing unit 301 delivers the system-configuration definition file 108 and the system fail-over definition file 109 to each machine on the system. Each machine starts up the DB processing servers based on the system-configuration definition file 108, and operates the system fail-over function based on the system fail-over definition file 109. This operating state becomes basically the same as the case in the first embodiment.

In this way, in the present embodiment, it is possible to take advantage of the contents of the already-existing system-configuration definition file 108 when modifying the system fail-over function-unapplied system into the system fail-over function-applied configuration.

As having been explained so far, according to the database management system constructing device in the present embodiment, the database management system is constructed by inputting the already-existing system-configuration definition file. As a result, it becomes possible to reduce a load for re-inputting the system configuration of the already-existing database management system.

### Embodiment 3

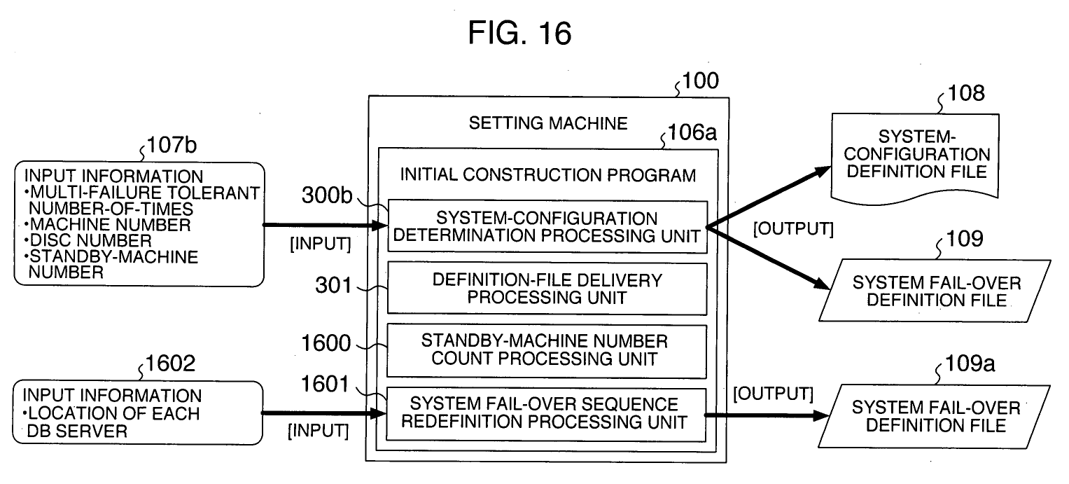

Next, referring to FIG. 16, the explanation will be given below concerning a third embodiment of the present invention,

The third embodiment of the database constructing system to which the present invention is applied makes it possible to specify, as an input value, a DB-processing-server location machine as the machine to be used specifically for standby. In this case, in the occurrence of failures up to the number of the standby-specific machines, all of the DB processing servers of a failed machine are switched into the standby machines. As a result, at the failure occurrence time, throughput of the entire system will not become lower up to the number of the standby machines. Simultaneously, at a failure occurrence time starting from a state where there exists no standby machine, the system fail-over is performed into the other remaining machines. This configuration lessens the lowering in the throughput of the entire system down to the smallest possible degree. The initial construction of this system will be facilitated.

FIG. 16 is a diagram for illustrating overview of the processing in the present embodiment. As illustrated in FIG. 16, an initial construction program 106a in the present embodiment includes a system-configuration determination processing unit 300b, the definition-file delivery processing unit 301, a standby-machine number count processing unit 1600, and a system fail-over sequence redefinition processing unit 1601. In the system fail-over sequence redefinition processing unit 1601, an input value as the input information 1602 is which of the machines each DB processing server is operating in. As the output, the unit 1601 outputs a system fail-over definition file 109a. Also, input information 107b includes a value for specifying the standby-machine number in addition to the information in the input information 107. The portion other than this is of the basically same configuration as the one in FIG. 1.

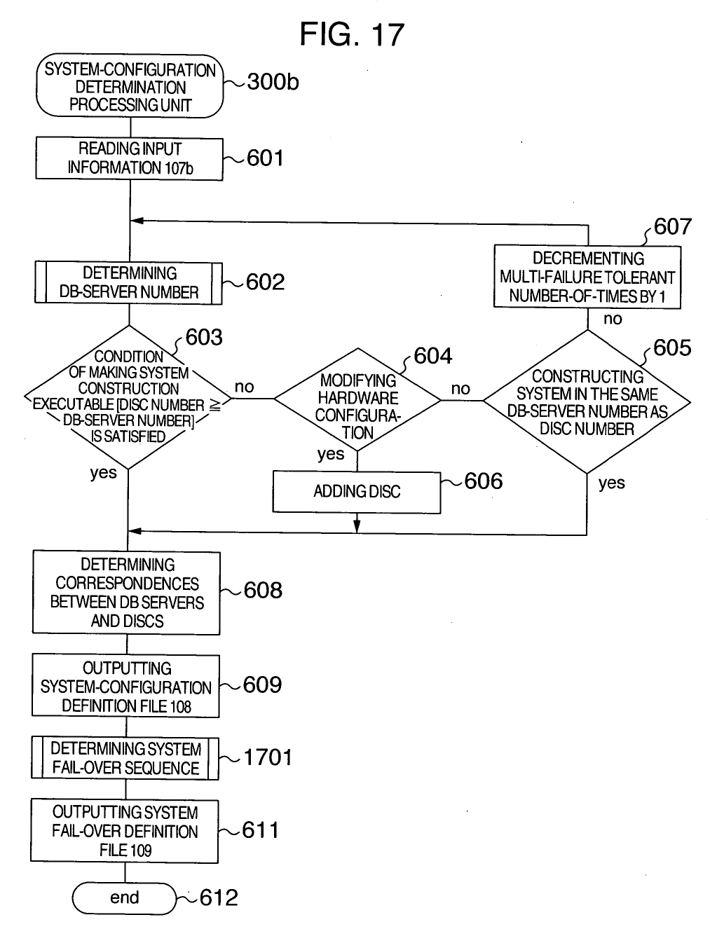

Hereinafter, referring to a flowchart illustrated in FIG. 17, the explanation will be given below concerning processing steps of the initial construction program 106a which, of processing steps in the present embodiment, differ from the ones in the first embodiment.

The processing steps illustrated in the present diagram differ, in a step 1701, from the processing steps of the system-configuration determination in the first embodiment illustrated in FIG. 6. Namely, the processing steps in the present diagram include the step 1701 in substitution for the step 610 illustrated in FIG. 6.

First, similarly in the first embodiment, the system-configuration determination processing unit 300b reads the input information at the step 601. Hereinafter, similarly in the first embodiment, the unit 300b determines the DB-processing-server number at the step 602. Also, it is assumed that the initial value of the operating-machine number at the time of determining the DB-processing-server number at the step 602 is a value resulting from subtracting the standby-specific machine number from the machine number specified in the input information 107b. Similarly in the first embodiment, the flow in FIG. 17 is caused to proceed to the step 609.

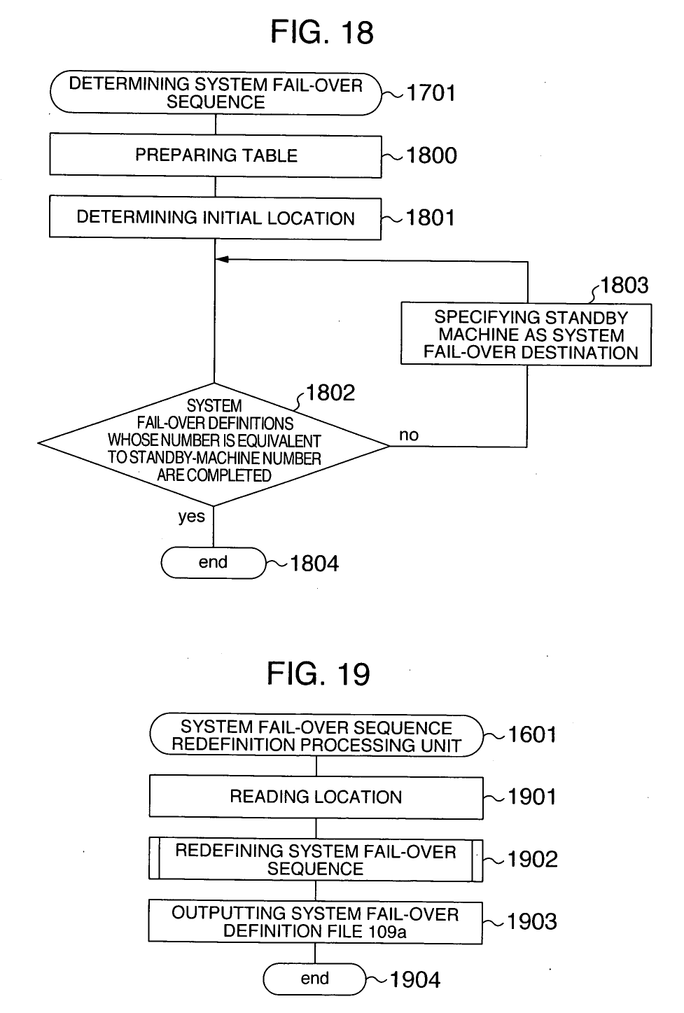

Next, in accordance with the step 1701, the unit 300b determines the system fail-over sequence. The system fail-over sequence will be determined at the step 1701 in accordance with a flowchart in FIG. 18.

First, at a step 1800, the system fail-over definition table 1000 is prepared. At this time, column number of the table is set at “the standby-machine number +1”. Next, at a step 1801, the initial location of all the DB processing servers is determined. This means that all the DB processing servers determined at the step 602 are located into each machine in an equal number. Moreover, at a step 1802, it is judged whether or not determinations of the system fail-over destinations have been completed by the number-of-times equivalent to the standby-machine number. If, in the judgment at the 1802, it is judged that the determinations have been not completed, the processing proceeds to a step 1803. At the step 1803, the system fail-over destinations are determined sequentially. This task is satisfying enough only to determine the system fail-over destinations in the case where a failure has occurred in any one of the machines. Accordingly, the standby-specific machines are specified as the system fail-over destinations. Meanwhile, if, at the 1802, the judgment result has been found to be the completion, the present flow is terminated.

Hereinafter, the processing contents at the step 611 are basically the same as the ones in the first embodiment.

Next, the definition-file delivery processing unit 301 delivers the system-configuration definition file 108 and the system fail-over definition file 109 to each of the machines configuring the database management system. Each of the machines configuring the database management system operates based on the system-configuration definition file 108. If a failure has occurred in a machine in which the DB processing servers are operating, each machine carries out the system fail-over based on the system fail-over definition file 109, thereby continuing the operation of the database management system.

Also, after the database management system has been operated, the standby-machine number count processing unit 1600 counts the number of the standby machines which are on standby in preparation for a failure occurrence in the database management system. The unit 1600 has, as the initial value, the standby-machine number specified in the input information 107b, then decrementing the initial value by “1” every time the system fail-over has occurred. When this initial value has become equal to “0”, the unit 1600 operates the system fail-over sequence redefinition processing unit 1601. A flowchart in FIG. 19 illustrates processing contents of this system fail-over sequence redefinition processing unit 1601.

FIG. 19 is the flowchart for illustrating the processing steps of the system fail-over sequence redefinition processing unit 1601 in the present embodiment. First, at a step 1901, the system fail-over sequence redefinition processing unit 1601 acquires the location information 1602 on the DB processing servers which are operating in each machine at the execution point-in-time of the present step. This is performed by making an inquiry thereabout to the system fail-over function 116 which is also operating in each machine. Moreover, at a step 1902, the unit 1601 redefines the system fail-over sequence at the time of a failure occurrence. This is performed by setting into which machine the system fail-over will be performed from a failed machine in which the DB processing servers are operating at present. Furthermore, at a step 1903, the unit 1601 outputs the information indicating the redefined system fail-over sequence as the system fail-over definition file 109a.

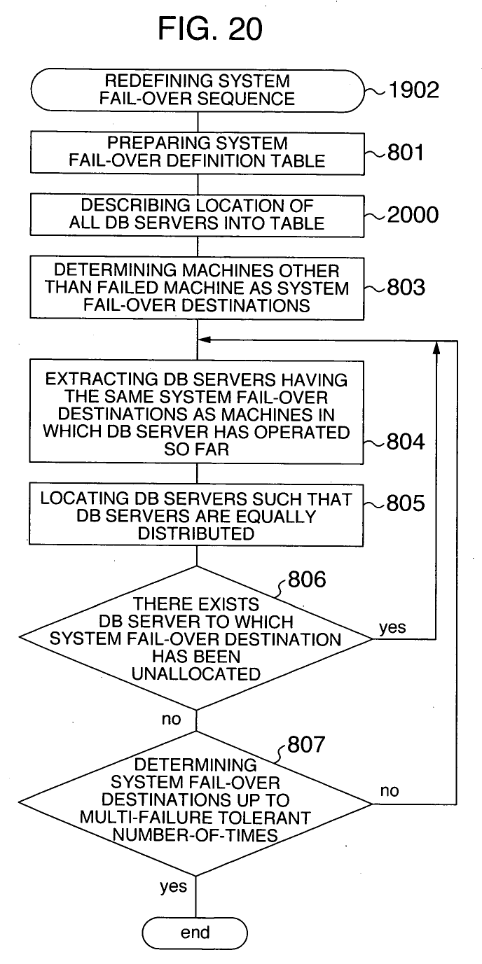

FIG. 20 is a flowchart for illustrating processing steps of the system fail-over sequence redefinition processing in the present embodiment. FIG. 20 illustrates details of the processing contents at the step 1902 in the flowchart in FIG. 19. The processing steps illustrated in FIG. 20 differ, in a step 2000, from the processing steps of the system fail-over sequence determination illustrated in FIG. 8. Namely, the processing steps in FIG. 20 include the step 2000 in substitution for the step 802 illustrated in FIG. 8.

At the step 801, similarly in the processing contents in the first embodiment, the system fail-over definition table 1000 is prepared.

The system fail-over definition table 1000 is a table for specifying machine names of the system fail-over destinations up to the multi-failure tolerant number-of-times. At the processing point-in-time, failures have occurred by the number-of-times equivalent to the standby-machine number, and the corresponding system fail-overs have been performed. Accordingly, the system fail-over definition table 1000 becomes the table corresponding to the system fail-overs by the number-of-times which results from subtracting the standby-machine number from the multi-failure tolerant number-of-times.

At the step 2000, the machine names in which the respective DB processing servers are operating at the processing point-in-time when the location information 1602 has been read at the step 1901 in FIG. 19 are determined as initial location machines.

Hereinafter, processing contents at the step 803, step 804, step 805, step 806, and step 807 are basically the same as those in the first embodiment.

Next, the definition-file delivery processing unit 301 delivers the system fail-over definition file 109a to each of the machines configuring the database management system. If a failure has occurred hereinafter, each machine will perform the system fail-over based on this system fail-over definition file 109a.

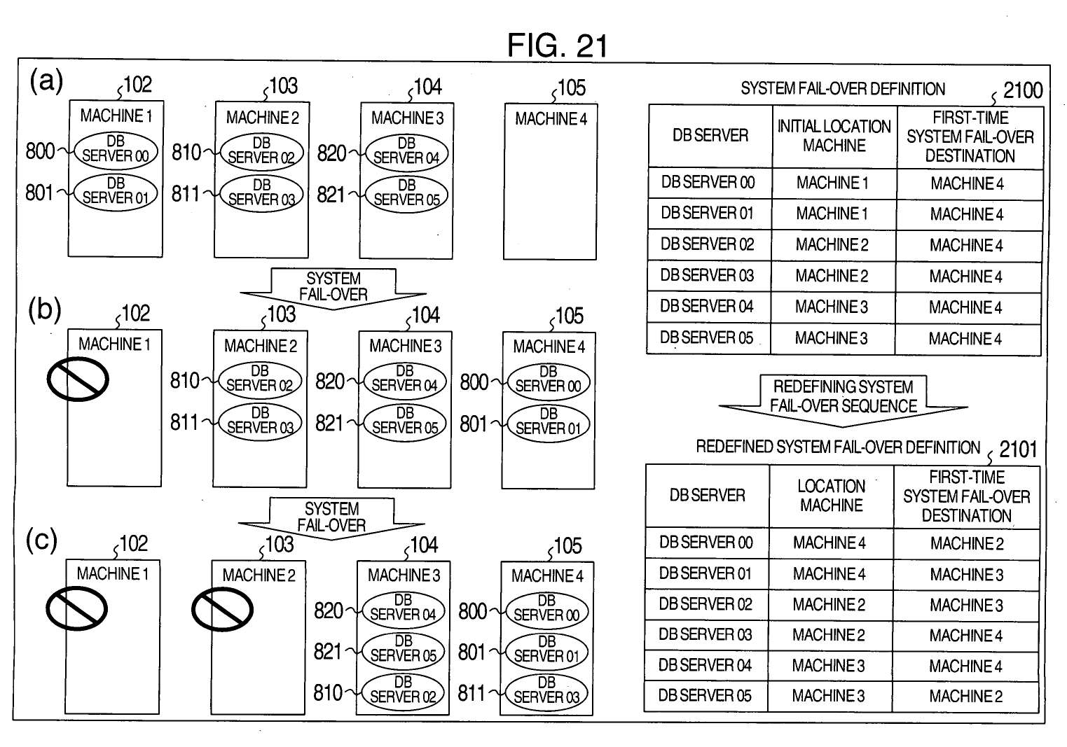

Next, referring to FIG. 21, the explanation will be given below concerning a concrete example in the case where, when constructing the database management system of the configuration in FIG. 9, the standby-specific machine number is specified at “1”.

First, the user inputs the input information 107b. Here, the standby-specific machine number is specified at “1”. The other input information is basically the same as the one in the first embodiment, and the multi-failure tolerant number-of-times is set at “2”. Hereinafter, in accordance with the flowchart in FIG. 17, the system definition will be determined. The system configuration determined in accordance with the flowchart in FIG. 17 turns out to become a one just like a diagram (a) in FIG. 21, where the DB processing servers which are “6” in number are located. Also, in the present example, the system fail-over definition 109 turns out to become a one just like a system fail-over definition 2100.

If a failure has occurred in the machine 1 (102) as is illustrated in a diagram (b) in FIG. 21, both the DB server 00 (800) and the DB server 01 (801) are switched into the machine 4 (105) in accordance with the system fail-over definition 2100. At this time, there exists no lowering in the throughput of the entire system.

Here, the standby-machine number becomes equal to “0” from “1” in the standby-machine number count processing unit 1600. As a result, the system fail-over sequence redefinition processing unit 1601 redefines the system fail-over sequence in accordance with the flowchart in FIG. 19. Here, the unit 1601 reads, at the step 1901, the location of the DB processing servers in each machine in the diagram (b) in FIG. 21, then outputting a redefined system fail-over definition 2101.

Moreover, if a failure has also occurred in the machine 2 (103) as is illustrated in a diagram (c) in FIG. 21, in accordance with the redefined system fail-over definition 2101, the DB server 02 (810) and the DB server 03 (811) are switched into the machine 3 (104) and the machine 4 (105), respectively.

As having been explained so far, according to the present embodiment, it becomes possible to construct the following system: Namely, even if a failure has occurred, the throughput of the entire system will not become lower as long as there remains the standby-specific machine. Also, even if there remains no standby-specific machine, the operation will be continued using the other machines which still remain at the failure occurrence time. This configuration prevents the throughput of the entire system from lowering up to the largest possible degree.

It should be further understood by those skilled in the art that although the foregoing description has been made on embodiments of the invention, the invention is not limited thereto and various changes and modifications may be made without departing from the spirit of the invention and the scope of the appended claims.

1. A database management system constructing method of constructing a database management system, said database management system storing a database such that said database is divided into a plurality of storage areas, and performing a data processing by causing a database processing server to be related to each storage area,
said constructing method, comprising the steps of:
creating a definition file and storing said definition file into storage devices, and
delivering said stored definition file to each of information processing devices via a communications device, said information processing devices configuring said database management system,
said definition file defining total number of said database processing servers in which database processing servers of an information processing device where a failure has occurred are equally distributable into a plurality of specified information processing devices other than said information processing device at said time of said failure occurrence corresponding to each number-of-times of multi-failure tolerant number-of-times which indicates tolerant number-of-times of multi failures, and
said information processing devices for executing said database processing servers.

2. The database management system constructing method according to claim 1, further comprising steps of:
inputting information from an already-existing system-configuration definition file, said information indicating number of said information processing devices, name and address of each information processing device, and number of said storage devices for storing database data and name of each storage device, and
creating said definition file including said pieces of information.

3. The database management system constructing method according to claim 1, further comprising a step of:
creating said definition file for performing system fail-over to machines to be used specifically for standby at said time of said failure occurrence if, at the time of initial construction of said database management system, number of said standby-specific machines had been inputted without operating said database processing servers.

4. The database management system constructing method according to claim 3, further comprising a step of:
redefining system fail-over sequence when said standby-specific machines in a standby state have been lost by carrying out said system fail-over due to said failure occurrence.

5. The database management system constructing method according to claim 1, further comprising a step of:
outputting, by an output device, a notification that said database processing servers of said information processing device where said failure has occurred cannot be equally distributed into said information processing devices other than said information processing device, if number of said storage devices is smaller than said total number of said database processing servers.

6. The database management system constructing method according to claim 2, further comprising a step of:
outputting, by an output device, a notification that said database processing servers of said information processing device where said failure has occurred cannot be equally distributed into said information processing devices other than said information processing device, if said number of said storage devices is smaller than said total number of said database processing servers.

7. The database management system constructing method according to claim 3, further comprising a step of:
outputting, by an output device, a notification that said database processing servers of said information processing device where said failure has occurred cannot be equally distributed into said information processing devices other than said information processing device, if number of said storage devices is smaller than said total number of said database processing servers.

8. The database management system constructing method according to claim 4, further comprising a step of:
outputting, by an output device, a notification that said database processing servers of said information processing device where said failure has occurred cannot be equally distributed into said information processing devices other than said information processing device, if number of said storage devices is smaller than said total number of said database processing servers.

9. The database management system constructing method according to claim 5, further comprising steps of:
receiving, by an input device, an additional instruction of adding said insufficient storage devices if said number of said storage devices is smaller than said total number of said database processing servers, and
storing, into said storage devices, said definition file where said number of said storage devices is modified into said value of said total number of said database processing servers.

10. The database management system constructing method according to claim 5, further comprising steps of:
receiving, by an input device, an instruction of constructing said system with said database processing servers whose number is equal to said number of said storage devices, if said number of said storage devices is smaller than said total number of said database processing servers, and
storing, into said storage devices, said definition file where said total number of said database processing servers is modified into said value of said number of said storage devices.

11. The database management system constructing method according to claim 5, further comprising a step of:
decrementing multi-failure tolerant number-of-times until said total number of said database processing servers has become smaller than said number of said storage devices, if said number of said storage devices is smaller than said total number of said database processing servers.

12. A database management system constructing device of constructing a database management system including a plurality of information processing devices,
said constructing device, comprising:
a system-configuration determination processing unit for creating a definition file and storing said definition file into storage devices, and
a definition-file delivery processing unit for delivering said stored definition file to each of said information processing devices via a communications device, said information processing devices configuring said database management system,
said definition file defining
total number of said database processing servers in which database processing servers of an information processing device where a failure has occurred are equally distributable into a plurality of specified information processing devices other than said information processing device at said time of said failure occurrence corresponding to each number-of-times of multi-failure tolerant number-of-times which indicates tolerant number-of-times of multi failures, and
said information processing devices for executing said database processing servers.

13. A program for causing a computer to execute a database management system constructing method of constructing a database management system including a plurality of information processing devices,
said constructing method, comprising the steps of:
creating a definition file and storing said definition file into storage devices, and
delivering said stored definition file to each of said information processing devices via a communications device, said information processing devices configuring said database management system,
said definition file defining total number of said database processing servers in which database processing servers of an information processing device where a failure has occurred are equally distributable into a plurality of specified information processing devices other than said information processing device at said time of said failure occurrence corresponding to each number-of-times of multi-failure tolerant number-of-times which indicates tolerant number-of-times of multi failures, and
said information processing devices for executing said database processing servers.

14. A computer-readable recording medium for recording a program,
said program being used for causing a computer to execute a database management system constructing method of constructing a database management system including a plurality of information processing devices, said constructing method, comprising the steps of:
creating a definition file and storing said definition file into storage devices, and
delivering said stored definition file to each of said information processing devices via a communications device, said information processing devices configuring said database management system,
said definition file defining total number of said database processing servers in which database processing servers of an information processing device where a failure has occurred are equally distributable into a plurality of specified information processing devices other than said information processing device at said time of said failure occurrence corresponding to each number-of-times of multi-failure tolerant number-of-times which indicates tolerant number-of-times of multi failures, and
said information processing devices for executing said database processing servers.
